(19) United States
(12) Patent Application Publication
(10) Pub. No.: US 2003/0008088 A1
(43) Pub. Date: Jan. 9, 2003

(54) Case for electronic parts

(76) Inventors: Naoki Matsubara, Minami-ashigara-shi Kanagawa (JP); Masaru Sato, Minami-ashigara-shi Kanagawa (JP); Koichi Ono, Tokyo (JP); Kazuhisa Senda, Fujisawa-shi Kanagawa (JP); Kiyohumi Fukasawa, Fujisawa-shi Kanagawa (JP); Jitsuhiko Hayashi, Tokyo (JP); Koichi Yokose, Tokyo (JP)

Correspondence Address: Michael S Gzybowski, Baker & Daniels, Suite 800, 111 East Wayne Street, Fort Wayne, IN, 46802, US

(21) Appl. No.: 10/169,285

(22) PCT Filed: Aug. 23, 2001
(86) PCT No.: PCT/JP01/07206

(30) Foreign Application Priority Data
Aug. 24, 2000 (JP) 2000-253515

(51) Int. Cl. B32B 1/02

(52) U.S. Cl. 428/35.7

(57) ABSTRACT

A case for electronic components comprises a metallic case and an electrically insulating exterior coating of an epoxy resin-based powder coating material comprising an epoxy resin, a phenolic curing agent, preferably poly(bisphenol A-hydroxypropyl ether) or poly(bisphenol F-2-hydroxypropyl ether) and a curing promoter, where the powder coating material applied to the metallic case as an electrically insulating exterior coating has distinguished coating film flexibility and adhesion to the metallic case without any cracking or peeling in the step to form an obturating portion of the open end of the metallic case and can be cured at a relatively low curing time for a relatively short time.

### TECHNICAL FIELD

The present invention relates to a case for electronic components and more particularly to a case for electronic components, which comprises a metallic case and an electrically insulating exterior coating of an epoxy resin-based powder coating material as applied to the outer surface of the metallic case.

### BACKGROUND ART

In the case of condensers such as aluminum electrolytic capacitors, electric double layer capacitors, etc., a component member comprising a separator, an electrolyte membrane (or electrolytic solution), etc., if required, together with a cushioning member, a gas pressure-controlling member, etc. is placed in a case, which is open on the top and closed on the bottom, and then the open end of the case is obturated with a obturation plate provided with terminals, a safety valve, a breather, etc. In the case of alkali primary batteries or secondary batteries such as nickel-cadmium secondary batteries, nickel-hydrogen batteries, lithium (ion) batteries, etc., an anode active material, a cathode active material, etc. are further added to the component member.

For electrically insulating exterior coating materials for these cases for electronic components such as capacitor cases, battery cases, etc., tubes made from polymer films of polyvinyl chloride, polyethylene, etc. have been so far used. However, many kinds of heat-shrinkable tubes are required due to a diversity of codes as to the capacitance of capacitors, the capacity of secondary batteries, etc., and the resulting their shapes, dimensions, color tones, etc., which have been a large bottleneck in the productivity increase of electronic components such as capacitors, secondary batteries, etc.

Among the conventional tubes, those of polyvinyl chloride have a good resistance to acids and alkalis, but a poor resistance to solvents and have particularly such a drawback that they are soluble in ketone-based solvents. Vinyl chloride-based resin must be avoided from use, also from the viewpoint of environmental protection.

The exterior casing tubes for use in the electrical insulation and protection of electronic components such as capacitors, secondary batteries, etc. are used in the final step of producing capacitors, secondary batteries, etc. When the exterior casing tubes are to be made by powder coating, heating to a higher temperature than that required for casing metallic cases with tubes of polyvinyl chloride, etc. is required in the final step of powder coating of metallic cases such as aluminum cases, stainless steel cases, etc., with the resulting damage to the properties per se of capacitors, secondary batteries, etc. Furthermore, the powders will be deposited even at other coating-unwanted components than the metallic case. Thus, masking is necessary for the powder coating, with the resulting productivity decrease.

That is, the powder coating must be applied to the metallic case per se. In that case, it is necessary to conduct a bending work such as curling, caulking, etc. of the open end of the powder coated metallic case in the step to form an obturating portion of the open end, where the powder coating film must be avoided from cracking or peeling due to the friction or deformation by external forces exerted on the metallic case, but the ordinary exterior coating films have problems of poor flexural strength, adhesion to the metallic case, etc., resulting in easy occurrence of cracking in or peeling of exterior coating films.

JP-A-5-320537 discloses a powder coating material for aluminum electrolytic capacitors, which comprises carboxylic acid-terminated polyester, epoxy resin and a curing promoter as essential components and also an aluminum electrolytic capacitor coated with the powder coating material, and mentions that in the obturating work of the aluminum case coated with the powder coating material occurrence of cracking in or peeling of the exterior coating material, i.e. film of the powder coating material can be successfully eliminated.

However, the powder coating material comprising carboxylic acid-terminated polyester, epoxy resin and a curing promoter has a tendency toward elevated curing temperature, and when the curing temperature is set to a lower level, the curing time will be elongated, anyway resulting in an adverse effect on the productivity. As shown in Comparative Example 5, which follows, cracking or peeling is unavoidable at the time of forming the obturating portion of aluminum cases, also with poor acetone resistance.

### DISCLOSURE OF THE INVENTION

An object of the present invention is to provide a case for electronic components, which comprises a metallic case for electronic components such as capacitors, secondary batteries, etc. and an electrically insulating exterior coating of powder coating material as applied to the outer surface of the metallic case, where the powder coating material can give distinguished film flexibility and adhesion to the metallic case, that is, without any occurrence of cracking or peeling in the step to form the obturating portion of the open end of the metallic case, and also can be cured at a relatively low curing temperature for a relatively short time.

The object of the present invention can be attained by a case for electronic components, which comprises a metallic case and an electrically insulating exterior coating of an epoxy resin-based powder coating material comprising an epoxy resin, a phenolic curing agent, preferably poly(bisphenol A-2-hydroxypropyl ether) curing agent and/or poly(bisphenol F-2-hydroxypropyl ether) curing agent, and a curing promoter.

Any of epoxy resins can be used as the main component of the epoxy resin-based powder coating material, so long as they contain at least two epoxy groups in the molecule, for example, epoxy resins of bisphenol A type, bisphenol F type, bisphenol S type, phenol-novolak type, cresol-novolak type, biphenyl type, trishydroxyphenylmethane type, tetraphenylolethane type, naphthalene type, heterocyclic type, alicyclic type, various modification type, etc. and also halogenized epoxy resins obtained by introduction of halogens to the aforementioned epoxy resins.

When an epoxy resin having two epoxy groups in the molecule and an epoxy resin of phenol-novolak type, cresol-novolak type, etc. having more than two epoxy groups in the molecule are used together in a ratio by weight of the former to the latter of about 3 -about 40, preferably about 5 -about 30, not only occurrence of cracking in or peeling of coating film can be suppressed when the open end of a metallic case is formed into the obturating portion by a bending work, but also such properties as a solvent resistance, a heat resistance, a high curing speed can effectively result in the coating film, and thus a powder coating material capable of satisfying the desired object of the present invention can be effectively obtained.

Phenolic curing agents, preferably poly(bisphenol F-2-hydroxypropyl ether) or poly(bisphenol A-2-hydroxy-propyl ether), which are diglycidylated modification products obtained by the reaction of bis(4-hydroxyphenyl)methane or 2,2-bis(4-hydroxyphenyl) propane with epichlorohydrin, can be used as a curing agent of the epoxy resins. The phenolic curing agents can be used in a proportion of preferably 0.4-1.2 moles, more preferably 0.5-1.1 moles as sum total of the phenolic hydroxyl groups to one equivalent of the epoxy groups of the epoxy resin. When the amount of the phenolic hydroxyl groups is less than 0.4 moles, the solvent resistance of the exterior coating material will be given an adverse effect, whereas in a proportion of more than 1.2 moles, cracking will be easy to occur at the bending work .

When phenolic resins, for example, phenol resins such as resols, novolaks, etc. obtained by condensation reaction of phenols (e.g. phenol, cresol, xylenol, resorcinol, etc.) with aldehydes (e.g. formalin, paraformaldehyde, etc.) are used as a curing agent in place of these phenolic curing agents, cracking or peeling will occur considerably at the bending work in spite of the distinguished solvent resistance. However, where a good solvent resistance is particularly required, the above-mentioned phenolic curing agent can be used together with the phenol resin-based curing agent within such a range as not to spoil the object of the present invention.

Curing promoters for use in the present invention include, for example, imidazoles such as 2-methylimidazole, 2-undecylimidazole, etc.; amines such as triisopropanolamine, etc.; phophines such as triphenylphosphine, etc.; and guanidines such as di-o-tolylguanidine, etc.

To satisfy minute requirements for characteristics of capacitors and secondary batteries, a filler, a levelling agent, a defoaming agent, a flame retardant, a flame retarding promoter, an adhesion promoter, pigments, a laser color coupler, etc. can be further added, if required, to the powder coating material comprising the above-mentioned essential components.

The powder coating material can be prepared by dry mixing in a Henschel mixer, etc., or by melt mixing through an extruder, etc., followed by high speed cooling and fine pulverization by a pulverizer to adjust the particle size to a required particle size distribution.

The particle size distribution for the present powder coating material is desirably adjusted to average particle sizes ranging preferably from about 5 to about 120 μm, more preferably from about 30 to about 70 μm. Distribution upper limit and lower limit depends on coating procedures, but the upper limit is about 150 μm, preferably about 120 μm, whereas as to the lower limit the particles of submicron order must be avoided to a minimum.

Surface treatment procedure for a metallic case is not particularly limited, so far as it can clean the metal surface and improve adhesion of the metal surface to a coating resin, and for example, an alkali treatment, an acid treatment, a blast treatment, etc. can be used. The surface treatment is also used as a pretreatment to increase the adhesion of the powder coating material to the metallic case. For aluminum cases, an alkali treatment or a blast treatment is suitable. The surface roughness resulting from such a surface roughening treatment is desirably in a range of about 0.2 to about 50 μm, preferably about 0.5 to about 20 μm.

To apply the powder coating material to metallic cases for electronic components such as capacitors, secondary batteries, etc. fluidized dipping, electrostatic fluidized dipping, electrostatic spraying, atomizing, sprinkling, rolling, flame spraying, etc. can be used. The applied powder coating material can be cured at about 100° -about 180° C. for about 3-about 60 minutes.

According to the present invention, cases for electronic components such as cases for capacitors, secondary batteries, etc., coated with a powder coating material as an electrically insulating exterior coating can be provided, where neither cracking in nor peeling of coating film occurs against friction or deformation due to external forces on the metallic case during the bending work such as curling, caulking, etc. to form an obturating portion of the open end of the metallic case after the application of the powder coating material to the metallic case and also curing of the applied coating material can be carried out at a relatively low temperature for a relatively short time.

### BEST MODES FOR CARRYING OUT THE INVENTION

The present invention will be described below, referring to Examples.

### EXAMPLES 1

| | Parts by weight |
|---|---|
| Bisphenol A type epoxy resin | 90 |
| (epoxy equivalent: 950) | |
| o-Cresol-novolak type epoxy resin | 10 |
| (epoxy equivalent: 220) | |
| Poly (bisphenol A-2-hydroxypropyl | 88 |
| ether (hydroxyl group equivalent: | |
| 700) | |
| Triphenylphosphine | 1 |
| Titanium oxide | 1 |
| Red iron oxide (Fe₂O₃; pigment for | 1 |
| brown coloring) | |
| Levelling agent (Acronal 4F, made | 0.2 |
| by BASF Japan) | |

Powder coating material, obtained by mixing the foregoing components, was applied to a capacitor aluminum case by electrostatic spray coating to a film thickness of 150±20 μm and cured in an oven of hot air circulation type at 120° C. for 20 minutes to obtain a test piece for evaluation.

Surface pretreatment of capacitor aluminum cases for the evaluation was carried out in the following two procedures, but both procedures showed the same results of cracking state and peeling state at the time of formation of the obturating portion of aluminum cases.

### Base Surface Pretreatment Procedure 1

Untreated cases were dipped in an aqueous 3N sodium hydroxide solution at 25° C. for 10 minutes, then washed with city water for 30 seconds and dried at room temperature.

### Base Surface Pretreatment Procedure 2

Untreated cases were blasted with silica (average particle size : 20 μm) for 40 seconds by a sand blaster, then air blown for 20 seconds, washed with methyl ethyl ketone for 5 minutes in an ultrasonic washing machine and dried at room temperature.

Cracking state and peeling state of the test pieces for evaluation by bending work to form the obturating portion of the open end thereof by caulking were visually inspected for evaluation according to the following standard:

⊙: Neither cracking nor peeling

◯: Neither cracking nor peeling, but whitening at the obturated surface

Δ: Slightly cracked and peeled

X: Considerably cracked and peeled

Acetone resistance (by 10 reciprocations of wiping with an acetone-impregnated fabric) was investigated for evaluation according to the following standard:

⊙: Luster was maintained on the coating film

◯: Luster was slightly lowered

Δ: Frosted on the coating film

X: Considerably frosted

### EXAMPLE 2

In Example 1, the same amount of bisphenol F type epoxy resin (epoxy equivalent: 950) was used in place of bisphenol A type epoxy resin, and 0.6 parts by weight of 2-undecylimidazole was used in place of one part by weight of triphenylphosphine. The resulting test pieces were subjected to the same evaluation.

### EXAMPLE 3

In Example 1, 20 parts by weight of 90 parts by weight of bisphenol A type epoxy resin was replaced by bisphenol A type brominated epoxy resin (epoxy equivalent: 360), and the amount of poly (bisphenol A-2-hydroxypropyl ether) was changed to 110 parts by weight, while 0.6 parts by weight of 2-undecylimidazole was used in place of one part by weight of triphenylphosphine. The resulting test pieces were subjected to the same evaluation.

### COMPARATIVE EXAMPLE 1

| | Parts by weight |
|---|---|
| Bisphenol A type epoxy resin | 100 |
| (epoxy equivalent: 950) | |
| Phenol-novolak type phenol resin | 10 |
| (hydroxy group equivalent: 105) | |
| 2-undecylimidazole | 0.6 |
| Titanium oxide | 1 |
| Red iron oxide (Fe₂O₃) | 1 |
| Levelling agent (Acronal 4F) | 0.2 |

Preparation of test pieces from the foregoing components and evaluation were carried out in the same manner as in Example 1.

### COMPARATIVE EXAMPLE 2

In Comparative Example 1, 11 parts by weight of cresol-novolak type phenol resin (hydroxyl group equivalent: 120) was used in place of 10 parts by weight of phenol-novolak type phenol resin.

### COMPARATIVE EXAMPLE 3

In Comparative Example 1, 30 parts by weight of 100 parts by weight of bisphenol A type epoxy resin was replaced by bisphenol A type brominated epoxy resin (epoxy equivalent: 360), and 15 parts by weight of benzophenone tetracarboxylic acid anhydride was used in place of 10 parts by weight of phenol-novolak type phenol resin.

### COMPARATIVE EXAMPLE 4

In Comparative Example 1, 5 parts by weight of dicyamine diamide was used in place of 10 parts by weight of phenol-novolak type phenol resin and the amount of 2-undecylimidazole was changed to 0.2 parts by weight.

### COMPARATIVE EXAMPLE 5

In Comparative Example 1, 52 parts by weight of 100 part by weight of bisphenol A type epoxy resin was replaced by carboxylic acid-terminated polyester (ER-8101, made by Unikika, Ltd.) and no phenol-novolak type phenol resin was used, while the amount of 2-undecylimidazole was changed to 0.2 parts by weight.

Results of evaluation obtained in the foregoing Examples and Comparative Examples are shown in the following Table.

TABLE

| | Cracking and peeling at the | |
|---|---|---|
| | forming of the obturating | |
| | portion of the opening | |
| Example | end of aluminum case | Acetone resistance |
| Example 1 | ⊚ | ◯ |
| Example 2 | ⊚ | ◯ |
| Example 3 | ◯ | ◯ |
| Comp. Ex. 1 | X | ⊚ |
| Comp. Ex. 2 | X | ⊚ |
| Comp. Ex. 3 | X | Δ |
| Comp. Ex. 4 | Δ | Δ |
| Comp. Ex. 5 | X | X |

1. A case for electronic components, which comprises a metallic case and an electrically insulating exterior coating of an epoxy resin-based powder coating material comprising an epoxy resin, a phenolic curing agent and a curing promoter.

2. A case for electronic components according to claim 1, wherein the phenolic curing agent is poly (bisphenol A-2-hydroxypropyl ether) or poly (bisphenol F-2-hydroxypropyl ether).

3. A case for electronic components according to claim 1, the epoxy resin for use in the epoxy resin-based powder coating material is composed of an epoxy resin having two epoxy groups in the molecule and an epoxy resin having more than two epoxy groups in the molecule.

4. A case for electronic components according to claim 1, wherein the epoxy resin-based powder coating material is applied to a metallic case for bending work.

5. A case for electronic components according to claim 4, wherein the epoxy resin-based powder coating material is applied to a metallic case before the bending work.

6. A case for electronic components according to claim 5, wherein the metallic case is a surface-roughened metallic case.

7. A case for electronic components according to claim 1, wherein the metallic case is a capacitor case.

8. A case for electronic components according to claim 1, wherein the metallic case is a secondary battery case.
